(19) United States
(12) Patent Application Publication
(10) Pub. No.: US 2006/0231420 A1
(43) Pub. Date: Oct. 19, 2006

(54) Explosives detection sensor

(75) Inventors: Fernando H. Garzon, Santa Fe, NM (US); Eric L. Brosha, Los Alamos, NM (US); Rangachary Mukundan, Santa Fe, NM (US)

Correspondence Address: LOS ALAMOS NATIONAL SECURITY, LLC, LOS ALAMOS NATIONAL LABORATORY, PPO. BOX 1663, LC/IP, MS A187, LOS ALAMOS, NM, 87545, US

(73) Assignee: The Regents of the University of California

(21) Appl. No.: 11/110,278

(22) Filed: Apr. 19, 2005

(51) Int. Cl. G01N 27/26

(52) U.S. Cl. 205/775; 204/400

(57) ABSTRACT

A solid state electrochemical gas sensor for detecting trace amounts of explosive materials and a method of detecting such explosives. The sensor has at least two electrodes. The at least two electrodes include a first catalytic electrode and a second catalytic electrode that are dissimilar and an electrolyte disposed between the first catalytic electrode and the second catalytic electrode. The sensor detects at least one gaseous specie emitted by the explosive material. At least one of a potential difference and a current flow is generated by at least one of catalytic and electrochemical reactions of the gaseous species emitted by the explosive material on one of the first catalytic electrode, second catalytic electrode, and the electrolyte. An explosive detection system that incorporates such sensors and methods is also described.

### STATEMENT REGARDING FEDERAL RIGHTS

This invention was made with government support under Contract No. W-7405-ENG-36, awarded by the U.S. Department of Energy. The government has certain rights in the invention.

### BACKGROUND OF INVENTION

The invention relates the detection of explosives. More particularly, the invention relates to a method of sensing explosives. Even more particularly, the invention relates to a method of detecting explosives using a solid-state, mixed potential sensor.

The ability to detect the presence of explosives is of great interest in both security and industrial applications. Explosive detection falls into two categories: bulk detection of explosives and trace detection of explosive residue. Whereas some form of gamma spectroscopy is used for the detection of bulk explosives, a variety of instruments, such as ion mobility spectrometers, electron capture detectors, gas chromatographs, mass spectrometers, chemiluminescence detectors, and field ion spectrometers, have been deployed for the trace detection of explosives. While most of these methods have excellent detection limits and are compatible with vapor phase or swipe sampling, they require relatively expensive instrumentation and are frequently large in size.

Electrochemical gas sensors, including mixed potential gas sensors, have been developed for combustion control and environmental monitoring applications. Such devices typically comprise two different catalytic electrodes deposited on a solid electrolyte. Multiple oxidation-reduction (also referred to hereinafter as “redox”) reactions occurring between gases and the electrodes give rise to mixed electrical potentials between the dissimilar electrodes. Examples of such electrochemical devices include sensors for carbon monoxide (CO), nitrogen oxide (also referred to hereinafter as “NOx”) and hydrocarbons. However, the lack of stability, reproducibility, and selectivity of such sensors has hindered their widespread use.

Although the state of explosive detection technology provides acceptable detection capability, there is no inexpensive alternative that will permit more widespread use of such detectors. The lack of stability, reproducibility, and selectivity of current gas sensors precludes them from potential use in the explosive detection field. Therefore, what is needed is a gas sensor that is capable of detection of trace amounts of explosives. What is also needed is a method of detecting explosives using such sensors. Finally, what is needed is an explosive detection system that incorporates such sensors.

### SUMMARY OF INVENTION

The present invention meets these and other needs by providing electrochemical gas sensors that for detecting trace amounts of explosive materials and a method of detecting such explosives. An explosive detection system that incorporates such sensors and methods is also described.

Accordingly, one aspect of the invention is to provide a system for detecting the presence of an explosive material. The system comprises: at least one solid state electrochemical sensor; a sampler in fluid communication with the at least one solid state electrochemical sensor, wherein the sampler provides a gaseous sample to the solid state electrochemical sensor; and a detector. The solid state electrochemical sensor comprises at least two electrodes. The at least two electrodes comprise a first catalytic electrode and a second catalytic electrode, wherein the first catalytic electrode and the second catalytic electrode are dissimilar, and an electrolyte disposed between the first catalytic electrode and the second catalytic electrode. The at least one solid state electrochemical sensor detects at least one gaseous specie emitted by the explosive material. The detector detects at least one of a potential difference and a current flow between the first catalytic electrode and the second catalytic electrode, the at least one of a potential difference and a current flow being generated by at least one of catalytic and electrochemical reactions of the gaseous species emitted by the explosive material on one of the first catalytic electrode, second catalytic electrode, and the electrolyte.

A second aspect of the invention is to provide a solid state electrochemical sensor for detecting at least one gaseous specie emitted by an explosive material. The sensor comprises: at least two electrodes, the at least two electrodes comprising a first catalytic electrode and a second catalytic electrode electrically coupled to each other, wherein the first catalytic electrode and the second catalytic electrode are dissimilar, and an electrolyte disposed between the first catalytic electrode and the second catalytic electrode. The at least one gaseous specie emitted by the explosive material catalytically or electrochemically reacts with each of the first electrode and the second electrode to produce at least one of a potential and a current flow between the first catalytic electrode and the second catalytic electrode that corresponds to a concentration of the at least one gaseous specie, wherein the at least one of potential and current flow is indicative of the presence of the explosive material.

A third aspect of the invention is to provide a system for detecting the presence of an explosive material. The system comprises: at least one solid state electrochemical sensor for detecting at least one gaseous specie emitted by an explosive material; a sampler in fluid communication with the at least one solid state electrochemical sensor, wherein the sampler provides a gaseous sample to the solid state electrochemical sensor; a detector; and a processor coupled to the detector. The at least one sensor comprises: at least two electrodes, the at least two electrodes comprising a first catalytic electrode and a second catalytic electrode electrically couple to each other, wherein the first catalytic electrode and the second catalytic electrode are dissimilar, and an electrolyte disposed between the first catalytic electrode and the second catalytic electrode. The at least one gaseous specie emitted by the explosive material catalytically reacts with each of the first electrode and the second electrode, producing at least one of a potential and a current flow between the first catalytic electrode and the second catalytic electrode corresponding to a concentration of the at least one gaseous specie, wherein the at least one of a potential and a current flow is indicative of the presence of the explosive material. The detector detects the at least one of a potential difference and a current flow between the first catalytic electrode and the second catalytic electrode, the at least one of a potential difference and a current flow being generated by catalytic reactions between the gaseous species emitted by the explosive material. The processor converts the at least one of a potential difference and a current flow into the concentration of at least one of the gaseous species emitted by the explosive material, and determines whether the explosive material is present based upon the concentration of the gaseous species.

A fourth aspect of the invention is to provide a method of detecting the presence of an explosive material. The method comprises the steps of: providing a solid state electrochemical sensor, the electrochemical sensor comprising a first catalytic electrode and a second catalytic electrode, and an electrolyte disposed between the first catalytic electrode and the second catalytic electrode, the first catalytic electrode and the second catalytic electrode being dissimilar; providing a gaseous sample from a first composition to the solid state electrochemical sensor, wherein at least one gaseous specie emitted from the explosive material, when present in the gaseous sample, reacts with each of the first catalytic electrode and the second catalytic electrode to produce at least one of a potential and a current flow between the first catalytic electrode and the second catalytic electrode; and detecting the at least one of a potential and a current flow, wherein the at least one of a potential and a current flow is indicative of the presence of the explosive material in the first composition.

These and other aspects, advantages, and salient features of the present invention will become apparent from the following detailed description, the accompanying drawings, and the appended claims.

### BRIEF DESCRIPTION OF THE DRAWINGS

FIG. 1 is a schematic diagram of a system for detecting the presence of explosive materials;

FIG. 2a is a schematic representation of a first embodiment of a sensor that may be incorporated in the system shown in FIG. 1;

FIG. 2b is a schematic representation of a second embodiment of a sensor that may be incorporated in the system shown in FIG. 1;

FIG. 3 is a plot of the response of a Pt/YSZ/La_{0.8}Mg_{0.2}CrO₃ sensor at 500° C. for known concentrations of NO₂;

FIG. 4 is a plot of sensor response at zero bias as a function of time for a sample comprising a) a 40% nitroglycerin-nitrocellulose mixture (smokeless powder), b) a mixture of ammonium nitrate/fuel oil, and c) urea;

FIG. 5 is a plot of sensor response at a 50 nanoamp (namp) bias as a function of time for a sample comprising a) a 40% nitroglycerin-nitrocellulose mixture (smokeless powder), b) a mixture of ammonium nitrate/fuel oil, and c) urea;

FIG. 6 is a plot of NO₂ concentration for each of the compounds shown in FIG. 5;

FIG. 7 is a plot of sensor response at zero bias as a function of time for a sample comprising a) ethanol and b) heptane; and

FIG. 8 is a plot of sensor response for smokeless powder as a function of time for smokeless powder at sample flow rates of a) 50 cc/min, and b) 10 cc/min.

### DETAILED DESCRIPTION

In the following description, like reference characters designate like or corresponding parts throughout the several views shown in the figures. It is also understood that terms such as “top,” “bottom,” “outward,” “inward,” and the like are words of convenience and are not to be construed as limiting terms. In addition, whenever a group is described as either comprising or consisting of at least one of a group of elements and combinations thereof, it is understood that the group may comprise or consist of any number of those elements recited, either individually or in combination with each other.

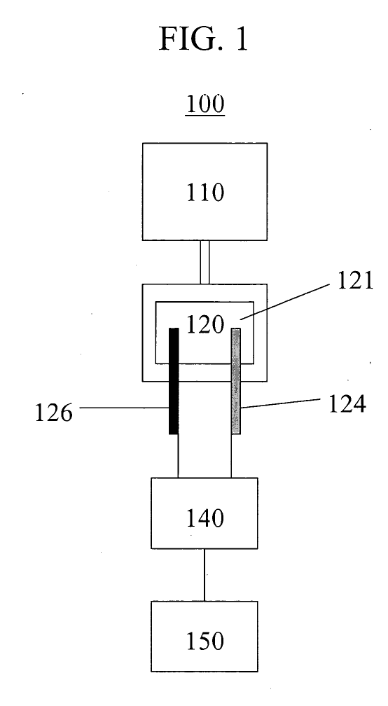

Referring to the drawings in general and to FIG. 1 in particular, it will be understood that the illustrations are for the purpose of describing a particular embodiment of the invention and are not intended to limit the invention thereto. FIG. 1 is a schematic diagram of system for detecting explosive materials. System 100 includes at least one solid state electrochemical sensor 120; a sampler 110 in fluid communication with the at least one solid state electrochemical sensor 120, wherein the sampler provides a gaseous sample to the solid state electrochemical sensor; and a detector 140.

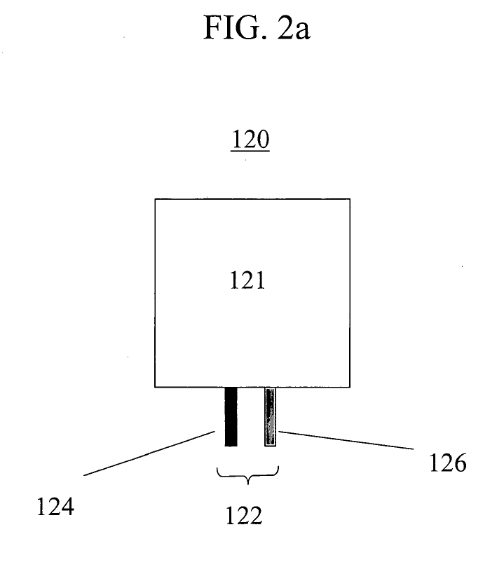

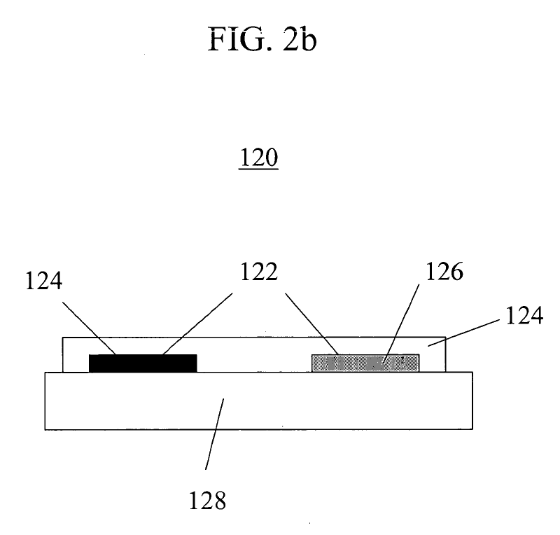

A schematic representation of one type of solid state electrochemical sensor 120 that may be used in system 100 is shown in FIG. 2a. The at least one solid state electrochemical sensor (also referred hereinafter as “sensor”) 120 detects at least one gaseous specie emitted by the explosive material. The solid state electrochemical sensor 120 comprises at least two solid electrodes 122 and an electrolyte 121 disposed between the at least two electrodes 122. The at least two solid electrodes 122 comprise a first catalytic electrode 124 and a second catalytic electrode 126 electrically coupled to each other, wherein the first catalytic electrode 124 and the second catalytic electrode 126 are dissimilar. First catalytic electrode 124 and second catalytic electrode 126 may, for example, comprise a platinum wire and a La_{0.8}Mg_{0.2}CrO₃ (also referred herein as “LCO”) pellet, respectively.

The at least two solid electrodes 122 include at least one of a wire, a pellet, a foil, and combinations thereof. Each of the at least two solid electrodes 122 comprises at least one electronically conductive material. The electronically conductive material has an electronic conductivity greater than 10 mS/cm at a temperature in a range from about 300° C. to about 1000° C. The at least one electronically conductive material is one of a metal oxide, a metal, a semiconductor, and combinations thereof. In one embodiment, the metal oxide is an oxide of one of a Group II metal, a Group IV metal, and combinations thereof. In one embodiment, the metal oxide is an oxide having one of a rock salt crystal structure, a fluorite crystal structure, a perovskite crystal structure, and a spinel crystal structure. In a third embodiment, the at least one electronically conductive material comprises at least one noble metal or alloys thereof. In a preferred embodiment, the at least one electronically conductive material comprises at least one of platinum, gold, a lanthanide based oxide, a doped zirconium based oxide, and combinations thereof. Lanthanide based oxides include, but are not limited to, lanthanum chromium based oxides, lanthanum cobalt based oxides, lanthanum manganese based oxides, and combinations thereof. Zirconium based oxides include, but are not limited to, terbium doped zirconium based oxides.

Electrolyte 121 is disposed between the at least two solid electrodes 122. Electrolyte 121 may comprise an ionic material such as, but not limited to, inorganic oxides having one of a fluorite crystal structure, a brown-millerite crystal structure, a pyrochlore crystal structure, a perovskite crystal structure, and a beta-alumina crystal structure. In one embodiment, electrolyte 121 is one of yttria-stabilized zirconia, gadolinia-stabilized ceria, and combinations thereof.

Sensor 120 involves the use of dense electrodes 121 in conjunction with either porous or dense electrolytes. Sensors of such designs have excellent long-term stability and device-to-device reproducibility. In one embodiment, described in U.S. Pat. No. 6,605,202, by Rangachary Mukundan et al., entitled “Electrodes for Solid State Gas Sensor,” issued Aug. 12, 2003, and United States Patent Application Publication US 2004/0016104 A1, by Rangachary Mukundan et al., entitled “Electrodes for Solid State Gas Sensor,” published on Jan. 29, 2004, two metal wire electrodes 122 are embedded and co-sintered in an electrolyte 121. In another embodiment, described U.S. Pat. No. 6,656,336, by Rangachary Mukundan et al., entitled “Method for forming a Potential Hydrocarbon Sensor with Low Sensitivity to Methane and CO,” issued Dec. 2, 2003, a metal wire and an oxide pellet electrode are both embedded in an oxide electrolyte. In another embodiment, described in U.S. patent application Ser. No. 10/______, by Rangachary Mukundan et al., entitled “Tape-Cast Sensors and Method of Making,” filed concurrently herewith, either wire or pellet electrodes are embedded between two portions of a tape-cast electrolyte. In yet another embodiment, shown in FIG. 2b and described in U.S. patent application Ser. No. 10/760,924, by Fernando H. Garzon et al., entitled “Thin Film Mixed Potential Sensors,” filed on Jan. 20, 2004, sensor 120 comprises a thin film electrolyte 110 that partially covers two thin film electrodes 122, comprising either metals or oxides, that are in turn supported on an inert substrate 128. All four of these references are incorporated herein by reference in their entirety.

Commonly used explosive materials, such as nitroglycerin-based powders, ammonium nitrate/fuel oil mixtures (ANFO), Trinitrotoluene (TNT), Pentaerythritoltetranitrate (PETN), Cyclotrimethylenetrinitramine (RDX), Cyclotetramethylene-tetranitramine (HMX), and the like contain nitrate groups. These nitrate groups generate NO₂ when thermally decomposed, typically in the range from about 200° C. to about 400° C. However, most common atmospheric contaminants, such as volatile organic compounds (VOCs), solvents, and urea, yield significant quantities of hydrocarbon-containing compounds when decomposed. System 100 and, in particular, sensor 120 must have the ability to distinguish between vapor species generated by explosive materials and contaminants found in the atmosphere.

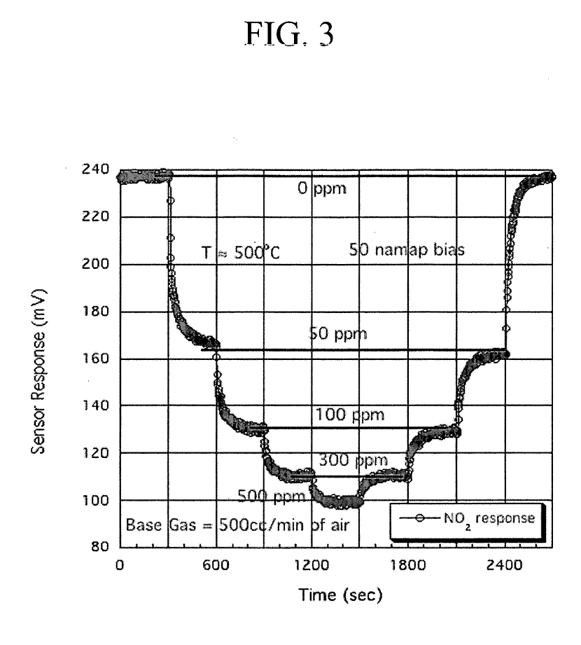

When a volume of gas containing NO₂ generated by the decomposition of an explosive material is provided to sensor 120, the NO₂ gas that is present reacts either electrochemically or catalytically with each of the at least two solid electrodes 122 and electrolyte 121. Because first catalytic electrode 124 and second catalytic electrode 126 are dissimilar, the reactions occurring between electrodes 122 and NO₂ create a potential—or voltage—between these electrodes 122 that is proportional to the NO₂ concentration. The potential is then detected by detector 140. Sensor 120 may be calibrated by measuring the potential generated by known NO₂ concentrations that are representative of NO₂ concentrations that are generated by explosive materials. Such a calibration of the response of a Pt/YSZ/LCO sensor at 500° C. for known concentrations of NO₂ is shown if FIG. 3. The potential is then compared to the potential generated by at least one known NO₂ concentration in order to determine the presence of an explosive.

In another embodiment, the electrochemical and catalytic reactions occurring between NO₂ and each of the at least two solid electrodes 122 and electrolyte 121 generates a current flow between first catalytic electrode 124 and second catalytic electrode 126. The current is detected by detector 140. In a manner similar to the calibration based upon the potential generated described above, sensor 120 may be calibrated based upon the current generated by known NO₂ concentrations.

Detector 140 may capable of detecting either the potential or current generated by the reactions between NO₂ and each of the at least two solid electrodes 122 and electrolyte 121, or detecting both current and potential simultaneously. Detector 140 may also comprise multiple voltage and potential detectors.

In one embodiment, detector 140 is coupled to a processor 150, which converts the potential difference or current detected by detector 140 into a NO₂ concentration and determines whether the explosive material is present based upon the NO₂ concentration. Processor 150 may analyze the type of explosive present by using, for example, pattern recognition software or certain characteristics of the response curves, such as, but not limited to, peak onset temperature, peak temperature, full width half maximum values (FWHM) of the peaks, the areas under the curves, and the like observed for gaseous products of different explosive materials, and compare obtained data to stored signal patterns of known explosive materials. Detector 140 is in communication with processor by any number of means such as, but not limited to, electrical wiring, fiber optics, wireless modes, and the like, either individually or in any combination with each other, that are known in the art.

In one embodiment, sensor 120 is a non-Nernstian sensor. For the purposes of understanding the invention, a non-Nernstian sensor is an electrochemical sensor in which the voltage deviates from the theoretical voltage obtained when all the gaseous species and charge carriers are in thermodynamic equilibrium with each other. In a particular embodiment, the non-Nernstian sensor is a mixed potential sensor; that is, a non-Nernstian sensor in which the voltage is determined by the reaction rates of at least two species undergoing simultaneous electrochemical oxidation/reduction reactions at the three-phase electrode/electrolyte/gas interface.

Sensor 120 may be operated in a zero voltage bias mode. In the zero current mode, the sensor behaves like a true mixed-potential sensor, where a voltage develops depending on the rates of the various electrochemical reactions occurring at the different electrodes. When sensor 120 is operated in the zero bias mode, non-methane hydrocarbons (NMHCs), NO, and CO yield a positive response while NO₂ yields a negative response.

Alternatively, sensor 120 may be operated in either one of a positive current bias mode and a positive voltage bias mode. In either of the positive voltage or positive current bias modes, the sensor response is a mixed potential response superimposed on a resistance change. Sensor 120 is highly sensitive in either bias mode to NO₂ that evolves from the decomposition of explosive materials. These operational modes have been utilized to distinguish between various types of explosives and also to perform trace detection.

Sensor 120 may be operated at any reasonable current or voltage bias range, as long as the current is limited to maintain voltage within ±1V. The actual current or voltage bias needed to maximize sensor response depends on the total resistance of sensor 120 and its response to the individual gases at zero bias.

The response of sensor 120 to changing concentrations of NO₂ at 50 namp bias and at an operating temperature of 500° C. is illustrated in FIG. 3. This response can be fit to the equation:
R=311.8−104.92 log(x)

where R is the sensor response measured in mV and x is the concentration of NO₂ in ppm. When sensor 120 is operated at a 50 namp bias, the above equation is used as a calibration curve to convert the sensor potential to an equivalent NO₂ concentration, assuming that all the NOx is present in the form of NO₂. However, a similar NO calibration can be obtained and used in situations where there is NO present. Since these parameters are dependent on the collection system, sensor 120 is calibrated to the specific sampler 110 or collection system and sensor configuration of system 100. In one embodiment, each sensor is calibrated against various known explosives, and the signal patterns at zero-bias and positive bias are stored. These are then compared with the measured signal to determine the type of explosive material present.

Sampler 110, which is in fluid communication with sensor 120, provides a volume of gas to sensor 120. Sampler 110 may act as a “sniffer,” taking in air samples form the atmosphere. Such sniffers are known in the art of environmental monitoring, and typically include pumping systems for drawing in a gas at a predetermined flow rate. Alternatively, sampler 110 may be adapted to provide sensor with a gaseous sample generated from a solid, such as, for example a cloth or tissue that has been “swiped” over the surface of an object suspected of containing explosive material. In this instance, sampler 110 thermally decomposes the solid by resistance heating or by a laser “flash,” for example, and provides the gaseous decomposition products to sensor 120 at a predetermined rate.

The following examples illustrate some of the advantages and features of the invention, and are not intended to limit the invention thereto.

### EXAMPLE 1

The following example demonstrates the ability of sensor 120 to detect the presence of explosive materials. A commercially available 40% nitroglycerin-nitrocellulose mixture of smokeless powder (BE) and Ammonium Nitrate/Fuel Oil (ANFO) were used as explosive materials. Urea and VOCs were used as interference compounds.

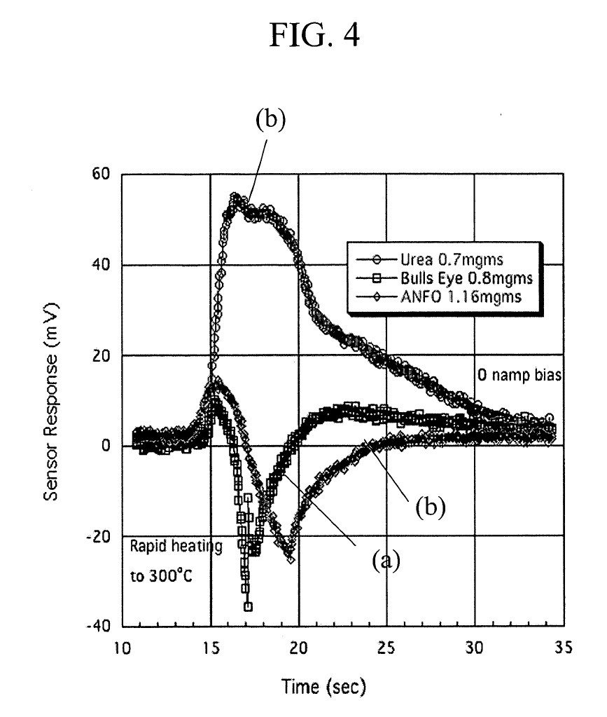

In the zero bias mode of operation, NMHCs, NO and CO yield a positive response of sensor 120, whereas NO₂ yields a negative response. FIG. 4 is a plot of sensor response as a function of time for a sample comprising BE, ANFO, and urea that was rapidly heated to 300° C. in a furnace. As the sample decomposes, the vapors are carried into sensor 120 at 500 cc/min by air flowing through the sample tube that is in turn connected to a heated tube containing sensor 120. As seen in FIG. 4, both ANFO ((b) in FIG. 4) and BE ((c) in FIG. 4) yield negative responses, while urea ((c) in FIG. 4) yields a large positive response. The shape of the response curves obtained for ANFO and BE show that there is an initial positive response followed by a larger negative response. This initial positive response could be due to the evolution of NO or HCs which are then overwhelmed by the evolution of NO₂.

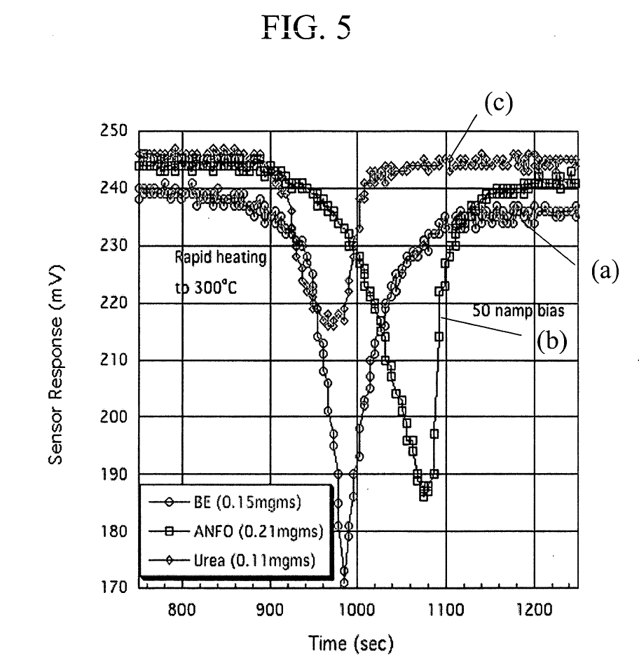

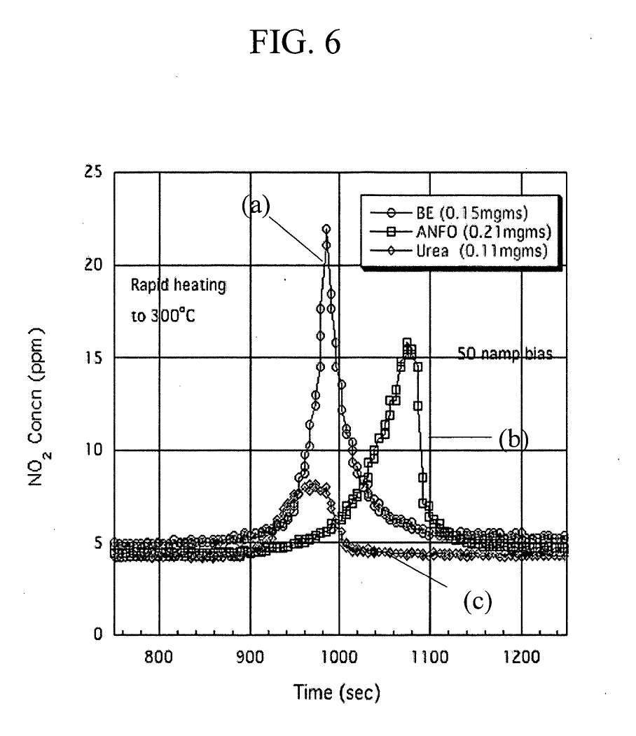

Sensor response at a 50 namp bias to: a) BE; b) ANFO; and c) urea is shown in FIG. 5. All three of these nitrate-containing compounds evolve NO₂. Using the calibration curve shown in FIG. 3, the sensor potential was converted to a NO₂ concentration for each of the compounds (FIG. 6). Using either pattern recognition software (included in the processor, for example) or certain characteristics of the response curves, such as, for example, peak onset temperature, peak temperature, full width half maximum values (FWHM) of the peaks, or the areas under the curves observed for these three materials, the NO₂ concentration curves shown in FIG. 6 can be utilized to differentiate between and analyze the type of explosive—or explosives—present. Any of these parameters—either individually or in combination with each other—may be compared to databases of explosive materials that may be stored in the processor.

### EXAMPLE 2

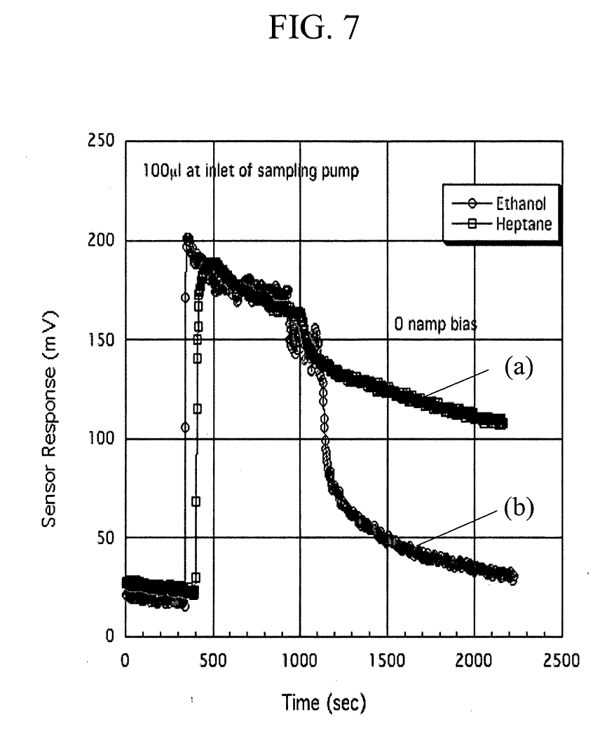

The following example demonstrates the ability of sensor 120 to distinguish between explosive vapors and other solvent vapors that could be present in the atmosphere. In this example, room air was pumped into the sensor 120 at a flow rate of 500 cc/min using a displacement pump. Next, 100 ml of either ethanol ((b) in FIG. 7) or heptane ((a) in FIG. 7) were then introduced near the inlet of the pump. The vapors of these organic compounds produced a large positive zero bias mode response in sensor 120, as shown in FIG. 7. In contrast to the positive response of sensor 120 to the organic vapors, explosive materials such as BE and ANFO generate a negative response in the zero bias mode, as seen in FIG. 4.

### EXAMPLE 3

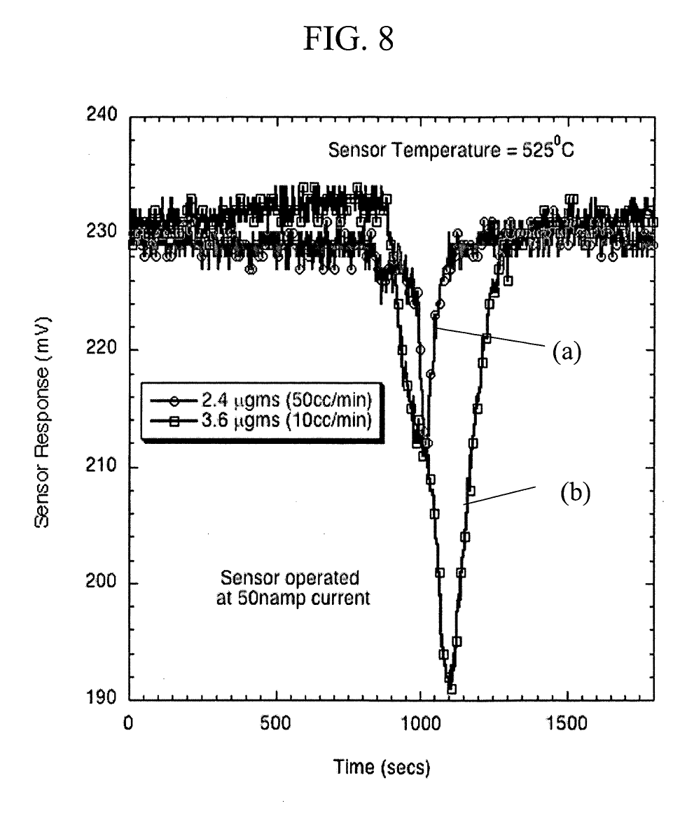

The following example demonstrates the ability sensor 120 and system 100 to detect trace quantities of explosive materials. The flow rate of the system was lowered to 50 cc/min ((a) in FIG. 8) and 10 cc/min ((b) in FIG. 8) in order to detect 2.4 μg and 3.6 μg of BE, respectively. The response of sensor 120 is shown in FIG. 8. As seen in FIG. 8, the sensitivity of sensor 120 may be increased by decreasing the flow rate of gases. The results suggest that the sensitivity of sensor 120 and system 100 increased to substantially less than microgram (μg) quantities of explosives by tuning the collection system or by using sample concentration techniques.

Sensor 120 is also compatible with most commercially available sample collection systems and can be used to replace detectors of currently available trace explosive detection systems. Moreover, sensor 120 is capable of detecting microgram quantities of explosive materials using a rudimentary collection system, such as a heated sample-containing furnace tube provided with constant air flow, without using a pre-concentrator.

While typical embodiments have been set forth for the purpose of illustration, the foregoing description should not be deemed to be a limitation on the scope of the invention. Accordingly, various modifications, adaptations, and alternatives may occur to one skilled in the art without departing from the spirit and scope of the present invention.

We claim:

1. A system for detecting the presence of an explosive material, the system comprising:
a) at least one solid state electrochemical sensor, wherein the solid state electrochemical sensor comprises at least two electrodes, the at least two electrodes comprising a first catalytic electrode and a second catalytic electrode, wherein the first catalytic electrode and the second catalytic electrode are dissimilar, and an electrolyte disposed between the first catalytic electrode and the second catalytic electrode, wherein the at least one solid state electrochemical sensor detects at least one gaseous specie emitted by the explosive material;
b) a sampler in fluid communication with the at least one solid state electrochemical sensor, wherein the sampler provides a gaseous sample to the solid state electrochemical sensor;
c) a detector, wherein the detector detects at least one of a potential difference and a current flow between the first catalytic electrode and the second catalytic electrode, the at least one of potential difference and current flow being generated by at least one of catalytic and electrochemical reactions of the gaseous species emitted by the explosive material on one of the first catalytic electrode, second catalytic electrode, and the electrolyte.

2. The system according to claim 1, further comprising a processor coupled to the detector, wherein the processor converts the at least one of potential difference and current flow into a concentration of at least one of the gaseous species emitted by the explosive material, and wherein the processor determines whether the explosive material is present based upon the concentration of the at least one gaseous specie.

3. The system according to claim 1, wherein the sampler comprises a heating chamber in which gases of an unknown composition are evolved from a sample.

4. The system according to claim 1, wherein each of the first electrode and the second electrode are thin films, and wherein the electrolyte is a thin film disposed between the first catalytic electrode and the second catalytic electrode.

5. The system according to claim 1, wherein the at least two electrodes are partially embedded in the electrolyte.

6. The system according to claim 5, wherein the electrolyte is a tape-cast electrolyte, and wherein a portion of each of the at least two electrodes is embedded between the first portion and the second portion of the tape-cast electrolyte.

7. The system according to claim 5, wherein the electrolyte is sintered.

8. The system according to claim 5, wherein the at least two electrodes include at least one of a wire, a pellet, a foil, and combinations thereof.

9. The system according to claim 1, wherein the at least two electrodes are formed on a first surface of a substrate, and wherein a layer of the electrolyte is formed over a portion of the at least two electrodes.

10. The system according to claim 1, wherein each of the at least two electrodes comprises at least one electronically conductive material, wherein the at least one electronically conductive material is one of a metal oxide, a metal, a metal oxide, semiconductor, and combinations thereof, and wherein the electronically conductive material has an electronic conductivity greater than 10 mS/cm at a temperature in a range from about 300° C. to about 1000° C.

11. The system according to claim 7, wherein the metal oxide an oxide of a Group II metal, a Group IV metal, and combinations thereof.

12. The system according to claim 7, wherein the metal oxide is an oxide having one of a rock salt crystal structure, a fluorite crystal structure, a perovskite crystal structure, and a spinel crystal structure.

13. The system according to claim 7, wherein the at least one electronically conductive material is selected from a group consisting of at least one noble metal and alloys thereof.

14. The system according to claim 7, wherein the at least one electronically conductive material is one is one of platinum, gold, a lanthanide based oxide, a doped zirconium based oxide, and combinations thereof.

15. The system according to claim 11, wherein the lanthanide based oxide is one of a lanthanum chromium based oxide, a lanthanum cobalt based oxide, a lanthanum manganese based oxide, and combinations thereof.

16. The system according to claim 11, wherein the zirconium based oxide is terbium doped zirconium based oxide.

17. The system according to claim 1, wherein the electrolyte comprises an ionic conducting material, wherein the ionic conducting material is an oxide having one of a fluorite crystal structure, a brown-millerite crystal structure, a pyrochlore crystal structure, a perovskite crystal structure, and a beta-alumina crystal structure.

18. The system according to claim 1, wherein the electrolyte is one of yttria-stabilized zirconia, gadolinia-stabilized ceria, and combinations thereof.

19. The system according to claim 1, wherein the at least one solid state electrochemical sensor is operable in an open-current mode.

20. The system according to claim 1, wherein the at least one solid state electrochemical sensor is operable in a positive current bias mode.

21. The system according to claim 1, wherein the at least one solid state electrochemical sensor is operable in an open-voltage mode.

22. The system according to claim 1, wherein the at least one solid state electrochemical sensor is operable in a positive voltage bias mode.

23. The system according to claim 1, wherein the at least one solid state electrochemical sensor detects at least one of gaseous hydrocarbon species and gaseous nitrogen oxide species.

24. The system according to claim 1, wherein the at least one solid state electrochemical sensor detects at least one of gaseous hydrocarbon species and gaseous nitrogen oxide species at concentrations corresponding to the presence of less than about 1 μg of the explosive material.

25. The system according to claim 1, wherein the electrochemical sensor is a non-Nemstian sensor.

26. The system according to claim 25, wherein the non-Nemstian sensor is a mixed potential sensor.

27. A solid state electrochemical sensor for detecting at least one gaseous specie emitted by an explosive material, the sensor comprising:
a) at least two electrodes, the at least two electrodes comprising a first catalytic electrode and a second catalytic electrode electrically coupled to each other, wherein the first catalytic electrode and the second catalytic electrode are dissimilar, and
b) an electrolyte disposed between the first catalytic electrode and the second catalytic electrode, wherein the at least one gaseous specie emitted by the explosive material catalytically or electrochemically reacts with each of the first electrode and the second electrode, producing at least one of a potential and a current flow between the first catalytic electrode and the second catalytic electrode, the at least one of potential difference and current flow corresponding to a concentration of the at least one gaseous specie, and wherein the at least one of potential and current flow is indicative of the presence of the explosive material.

28. The sensor according to claim 27, wherein each of the first electrode and the second electrode are thin films, and wherein the electrolyte is a thin film disposed between the first catalytic electrode and the second catalytic electrode.

29. The sensor according to claim 27, wherein the at least two electrodes are partially embedded in the electrolyte.

30. The sensor according to claim 29 wherein the electrolyte is a tape-cast electrolyte, and wherein a portion of each of the at least two electrodes is embedded between the first portion and the second portion of the tape-cast electrolyte.

31. The sensor according to claim 29, wherein the electrolyte is sintered.

32. The sensor according to claim 29, wherein the at least two electrodes include at least one of a wire, a pellet, a foil, and combinations thereof.

33. The sensor according to claim 27, wherein the at least two electrodes are formed on a first surface of a substrate, and wherein a layer of the electrolyte is formed over a portion of the at least two electrodes.

34. The sensor according to claim 27, wherein each of the at least two electrodes comprises at least one electronically conductive material, wherein the at least one electronically conductive material is one of a metal oxide, a metal, a metal oxide, semiconductor, and combinations thereof, and wherein the electronically conductive material has an electronic conductivity greater than 10 mS/cm at a temperature in a range from about 300° C. to about 1000° C.

35. The sensor according to claim 34, wherein the metal oxide of one of a Group II metal, a Group IV metal, and combinations thereof.

36. The sensor according to claim 34, wherein the metal oxide is an oxide having one of a rock salt crystal structure, a fluorite crystal structure, a perovskite crystal structure, and a spinel crystal structure.

37. The sensor according to claim 34, wherein the at least one electronically conductive material is selected from a group consisting of at least one noble metal and alloys thereof.

38. The sensor according to claim 34, wherein the at least one electronically conductive material is one is one of platinum, gold, a lanthanide based oxide, a doped zirconium based oxide, and combinations thereof.

39. The sensor according to claim 38, wherein the lanthanide based oxide is one of a lanthanum chromium based oxide, a lanthanum cobalt based oxide, a lanthanum manganese based oxide, and combinations thereof.

40. The sensor according to claim 38, wherein the zirconium based oxide is terbium doped zirconium based oxide.

41. The sensor according to claim 27, wherein the electrolyte comprises an ionic conducting material, wherein the ionic conducting material is an oxide having one of a fluorite crystal structure, a brown-millerite crystal structure, a pyrochlore crystal structure, a perovskite crystal structure, and a beta-alumina crystal structure.

42. The sensor according to claim 27, wherein the electrolyte is one of yttria-stabilized zirconia, gadolinia-stabilized ceria, and combinations thereof.

43. The sensor according to claim 27, wherein the at least one solid state electrochemical sensor is operable in an open-current mode.

44. The sensor according to claim 27, wherein the at least one solid state electrochemical sensor is operable in a positive current bias mode.

45. The sensor according to claim 27, wherein the at least one solid state electrochemical sensor is operable in an open-voltage mode.

46. The sensor according to claim 27, wherein the at least one solid state electrochemical sensor is operable in a positive voltage bias mode.

47. The sensor according to claim 27, wherein the at least one solid state electrochemical sensor detects at least one of gaseous hydrocarbon species and gaseous nitrogen oxide species.

48. The sensor according to claim 27, wherein the sensor detects at least one of gaseous hydrocarbon species and gaseous nitrogen oxide species at concentrations corresponding to the presence of less than about 1 μg of the explosive material.

49. The sensor according to claim 27, wherein the electrochemical sensor is a non-Nernstian sensor.

50. The sensor according to claim 49, wherein the non-Nemstian sensor is a mixed potential sensor.

51. A system for detecting the presence of an explosive material, the system comprising:
a) at least one solid state electrochemical sensor for detecting at least one gaseous specie emitted by an explosive material, the at least one sensor comprising:
i) at least two electrodes, the at least two electrodes comprising a first catalytic electrode and a second catalytic electrode electrically couple to each other, wherein the first catalytic electrode and the second catalytic electrode are dissimilar, and
ii) an electrolyte disposed between the first catalytic electrode and the second catalytic electrode, wherein the at least one gaseous specie emitted by the explosive material catalytically reacts with each of the first electrode and the second electrode, producing at least one of a potential difference and a current flow between the first catalytic electrode and the second catalytic electrode, the at least one of potential difference and current flow corresponding to a concentration of the at least one gaseous specie, and wherein the at least one of potential difference and current flow is indicative of the presence of the explosive material;
b) a sampler in fluid communication with the at least one solid state electrochemical sensor, wherein the sampler provides a gaseous sample to the solid state electrochemical sensor;
c) a detector, wherein the detector detects the at least one of potential difference and current flow between the first catalytic electrode and the second catalytic electrode; and
d) a processor coupled to the detector, wherein the processor converts the at least one of potential difference and current flow into a concentration of at least one of the gaseous species emitted by the explosive material, and wherein the processor determines whether the explosive material is present based upon the concentration of the gaseous species.

52. A method of detecting the presence of an explosive material, the method comprising the steps of:
a) providing a solid state electrochemical sensor, the electrochemical sensor comprising a first catalytic electrode and a second catalytic electrode, and an electrolyte disposed between the first catalytic electrode and the second catalytic electrode, the first catalytic electrode and the second catalytic electrode being dissimilar;
b) providing a gaseous sample from a first composition to the solid state electrochemical sensor, wherein at least one gaseous specie emitted from the explosive material, when present in the gaseous sample, reacts with each of the first catalytic electrode and the second catalytic electrode to produce at least one of a potential difference and a current flow between the first catalytic electrode and the second catalytic electrode; and
c) detecting the at least one of potential difference and current flow, wherein the at least one of potential difference and current flow is indicative of the presence of the explosive material in the first composition.
